(19) United States
(12) Patent Application Publication
(10) Pub. No.: US 2019/0128710 A1
(43) Pub. Date: May 2, 2019

(54) SENSOR SIGNAL DETECTION APPARATUS

(71) Applicant: Mitsutoshi Sugawara, Kanagawa (JP)

(72) Inventor: Mitsutoshi Sugawara, Kanagawa (JP)

(21) Appl. No.: 16/091,803

(22) PCT Filed: Apr. 6, 2016
(86) PCT No.: PCT/JP2016/061182

§ 371 Date: Oct. 9, 2018

(51) Int. Cl. G01D 21/00

(52) U.S. Cl. CPC G01D 21/00

(57) ABSTRACT

In a conventional sensor signal detection device, an amplifier and an anti-alias analogue filter are essential for AD conversion of a small sensor output signal. The present application provides a sensor signal detection device that inputs an electric signal output from a sensor to a commercially available AD converter directly or via a means for converting the electric signal into voltage, outputs the electric signal via a digital filter, and realizes sufficient resolution and noise characteristics without using an amplifier and an analogue filter which have conventionally been considered to be essential, by devising conditions, etc., of an AD conversion clock and digital filter.

### TECHNICAL FIELD

The present invention relates to a device detecting all kinds of sensor signals, in particular to a device detecting the desired signals while reducing the noise of a minute sensor output signal.

### PRIOR ART

When processing all kinds of sensor signals, recently minute electrical signals from sensors are amplified and applied to a low pass filter (hereafter referred to as LPF), AD converted, and a digital comparison method is most commonly used.

### PRIOR ART TECHNOLOGY REFERENCES

### Patent References

Patent reference 1: Japanese laid open unexamined patent publication 2009-115710 “A variable capacitance measurement device and a variable capacitance measurement method”
Patent reference 2: Japanese laid open unexamined patent publication 2004-233356 “System and method of identifying a biopolymer moving through nanopore”.
Patent reference 3: WIPO International Patent Publication WO 2015/042200 “Biomolecule sequencing devices, systems and methods”.

### Non-Patent References

Non-patent reference 1: Texas Instruments “Analog front-end design for ECG system using Delta-Sigma ADCs” http://www.tij.co.jp/jp/lit/an/sbaa160a/sbaa160a.pdf
Non-patent reference 2: EDN Japan “Introduction to acceleration sensors that you haven't heard about lately” http://ednjapan.com/edn/articles/1205/16/news110_2.html
Non-patent reference 3: “Axopatch 200B Patch clamp theory and operation” https://www.autom8.com/doc/Axopatch-200B.pdf
Non-patent reference 4: “Datasheet DKPCA-100” http://fempto.de/images/pdf-dokumente.de-dhpca-100_tll.pdf

### OUTLINE OF THE PATENT

### Problems to be Solved by the Invention

In recent years, many kinds of sensors have been used in the fields of the Internet of Things (IOT), bioelectronics, automobiles, robots and the like.

When processing the sensor signals, the minute electrical signals from the sensors are amplified, applied to LPF, AD converted, and a digital comparison method is most commonly used. In that case, it is thought that amplification of the signal from the sensor is essential in order to match the input range to the A/D converter (hereafter abbreviated to ADC). Moreover, in order to suppress the aliasing distortion/aliasing noise of the frequency axis, it is considered essential to have an LPF which is less than half than the conversion clock of the ADC.

As the scale of an analogue circuit increases significantly with this configuration, it is difficult to use and the power consumption, size and cost cause problems.

For example, a device detecting a sensor signal outputting the minute voltage represented in FIG. 2 of this patent application is a block diagram of the generalised electrocardiogram represented in FIG. 3 of non-patent reference 1. The operation thereof involves inputting a ±2.5 millivolt order signal generated by the multiple electrodes (sensors) attached to the human body from the sensor electrodes to the terminals Elec 1-Elec 9, via a 5× amplifying INA, and an HPF for use in blocking DC and, following a 32× amplifier and a 150 Hz LPF with amplification to the order of ±400 millivolts, it is passed through a high pass filter (hereafter referred to as HPF) and digitally converted by means of a 16-bit ADC. These are analogue circuits which are of a scale requiring a printed circuit board which is 10 cm² and cause problems with power consumption, size, cost, and similar.

Furthermore, FIG. 3 of this patent application represents an improved version of FIG. 4 of non-patent reference 1 and passes the signal through a 5× amplifying INA and a resistance/capacitance (RC) type 150 Hz LPF and switching MUX with analogue-to-digital conversion in a 24-bit ADC (effective number of bits is 20 bits). While this has a great reduction in the number of parts compared to FIG. 2 of this patent application, they are still analogue circuits and are of a scale requiring a several centimeter square sized printed circuit board and still cause problems with power consumption, size, cost, and similar.

As the second example, the device of non-patent reference 2, FIG. 3 detects sensor signals outputting capacitance variation as shown in FIG. 5. The operation of this sensor involves the output of the capacitance variation between a pair of opposing electrodes C_{S1} and C_{S2}, wherein positional variation occurs in the variable part, caused by the force generated which is proportional to the acceleration. The electrical circuit processing the sensor output thereof applies the alternating current signal from an oscillator circuit across said opposing electrodes, converting the voltage division by the capacitance of the sensors C_{S1} and C_{S2} to an alternating voltage amplified by an amplifier circuit, and outputs the variability of a direct current voltage from a synchronous wave detector including a rectifier circuit. There is, of course, an LPF included in this rectifier circuit. This is, of course, an analogue circuit and is of a scale requiring a size of several square centimeters, with the associated problems of power consumption, size, cost and similar.

Moreover, while it is not clearly illustrated in non-patent reference 2, in many cases, said output is A/D converted and then subject to digital processing.

The third example is an embodiment represented in non-patent references 2 and 3 detecting sensor signals outputting minute electrical currents I_{S}. Each are devices for presupposing single molecules of DNA gene sequences, and the genes are derivable by sensor output of the minute tunnel currents when they flow through the extremely narrow parts which are to the order of a nanometer. According to paragraph 0062 of the first example of non-patent reference 2, the output tunnel current can be measured through use of a patch clamp amplifier. The contents thereof are disclosed in FIGS. 16 and 17 of non-patent reference 4, and a related item is represented in FIG. 7 of this patent application. According to this, a minute input current I_{f} flows into capacitance C_{f} from the sensor and is converted into a voltage by means of the integrator, the frequency characteristics thereof are corrected by the differentiator, amplified, and applied to an LPF to enable a voltage output. These are analogue circuits and are of a scale requiring a sensor with a size of the order of several tens of centimetres squared, with associated problems with power consumption, size, cost and similar. The voltage output of the above described patch clamp amplifier is digitised for the purposes of comparison with a database (it is clear that an ADC is used).

The tunnel current is detected by the ammeter 24 of FIG. 1 in non-patent reference 3 and is transferred to the control unit 26 (not illustrated in the figures). The conductance value in which the inverse of the applied voltage is applied to the current which is the output of this ammeter 24 is represented on the vertical axis of FIG. 3 and similar. FIG. 8 of this patent application represents a block diagram of the device cited in non-patent reference 4 which is described in paragraph 0167 of non-patent reference 3 as a device for processing said sensor output. According to this description, the current voltage conversion circuit I/V comprising an op amp and resistor R_{f} receiving the minute current input from the sensor and a device comprising the amplifiers X10 and X1 and an LPF are exemplified. These are all analogue circuits and are of a scale requiring a size of the order of 15 cm×5 cm, causing the same problems with power consumption, size, cost and similar. In order to enable CPU processing, the voltage output of the above described amplifier is digitised (it is clear that an ADC is used).

### Effects of the Invention

In the event of the present invention being applied, as the electrical signal from the sensor can be directly subjected to analogue-to-digital conversion, it may be beneficial that analogue circuits are almost completely removed. The following may be possible as a result: miniaturisation, reduction of power consumption and reduction of cost.

### SUMMARY OF THE INVENTION

In the present invention, the conventional disadvantage of having an amplifier is removed by first subjecting the sensor signal to direct analogue-to-digital conversion, this will be covered in greater detail below. However, depending on the sensor signal, a part may wrongly convert the sensor signal to a voltage.

Nevertheless, by merely removing the amplifier and the LPF from the conventional circuit, it becomes clear that insufficient discrimination or aliasing noise are generated and cannot be used, as the functions performed by the amplifier and the LPF have been removed. For that reason, the degree of discrimination and the sampling frequency of the ADC of this patent application are elevated to the amount necessary, to reduce the noise using a digital filter and this is resolved by reducing the reference voltage and similar.

### EMBODIMENTS OF THE PRESENT INVENTION

### Embodiment 1

FIG. 1 represents the first embodiment of this patent application and applies a digital filter for the purpose of differentiating the direct connection to the ADC of the electrocardiogram signal from the minute voltage output type sensor of non-patent reference 1, as explained in paragraph 0006. The patient protection and load selection block prevent the application of an abnormal voltage to the human body, as well as the selection of the required loading conditions of the sensor, and are not discussed in this patent application. Neither is there any debate in this patent application in relation to the circuit creating the output R_{L}. MUX is a switchover for the time division of the ADC.

Firstly, let us consider the problems with the output terminals of the ADC in this state. The switchover MUX selects the differentially operating two leads from among Elec 1-Elec 9 and, by inputting the ADC, the common mode noise does not cause a problem by being canceled by the differential.

However, as there is no amplifier in FIG. 1 of this patent application, the signal input to the ADC is still of the order of ±2.5 millivolts, and in the hypothetical event of the resolution of the ADC being the same as that of the 16-bit of the prior art example in FIG. 2 of this patent application, on enabling a full scale of 2.5 fold, the input signal would be very small at 1/1000≈2⁻¹⁰ times, and the higher order approximately 10-bit part would be useless and effectively only a degree of resolution of a ±6-bit ADC is derivable. At that level the absolute degree of resolution is insufficient.

In comparison with the block diagram of the prior art embodiment of FIG. 3 of this patent application, while the degree of resolution of the ADC is the same 24-bit, as there is no conventional 5× amplifier INA of FIG. 3 of this patent application in FIG. 1 of this patent application, there is the disadvantage that the resolution is five times enlarged (roughened). Now, on changing the full scale of the 24-bit ADC to 2.5 V, the output of the ADC of FIG. 1 is effectively a ±14-bit resolution.

Moreover, whereas in both of the prior art examples of FIGS. 2 and 3 of this patent application, where there is the provision of a 150 Hz antialiasing filter in order to remove the frequency aliasing noise of the high band noise resulting from the ADC, there is no such item in FIG. 1 of this patent application.

According to the observations of the inventors of this patent application, there is no need for an antialiasing filter, as there is no generation of frequency aliasing noise of the high band noise for the reasons cited in the following paragraph.

The reasons for this are that, firstly, the discarded signals of the multiple electrodes themselves (sensors) attached to the human body are not only very slow at less than 150 Hz, the upper limit of the frequency components of the response of noise in terms of the configuration of those electrodes and wiring is a sufficiently low frequency compared to 10 kHz. In other words, there is no noise above 10 kHz.

If an INA amplifier were to be inserted, as in the prior art embodiments, then there would be noise generated by the amplifier itself in the band above 10 kHz by the bands of the amplifier and it is highly likely that an antialiasing filter would be required as is conventionally the case. For that reason, an amplifier is not employed in this patent application.

Secondly, when the sampling frequency of the ADC is approximately 10 kHz with respect to the input channel (as there is time division by means of the MUX), according to the sampling theorem the frequency aliasing noise generated of the high band noise is 90 to 100 kHz, and as the sensor itself does not respond in that band, there is no generation of noise and there is no problem.

To elaborate slightly further, when the ADC is of the Delta Sigma type oversampling format, the frequencies sampled from an actual analogue signal are even higher than 10 MHz, and according to the sampling theorem the possibility for the generation of frequency aliasing noise of the high band noise is above 10 MHz. The actual sensors do not respond at 10 MHz and, as there is no noise in this band, there is no problem.

However, as there is effectively no filtering of noise in the ranges of 150 Hz˜5 MHz and less than 50 Hz, the noise in that bandwidth is analogue-to-digitally converted as it is and output.

The digital filter of FIG. 1 removes this. Firstly, an explanation is provided of the 150 Hz digital/LPF.

As to the methods of configuration of digital/LPF, Chebyshev type FIR filters or biquad type IIR filters and similar are known, and either type may be used.

As a simple embodiment of an FIR type digital LPF, there are moving average filters which normally use the average of a sequence of n units or the sum thereof. Since, in the end, when the larger and smaller among the data are compared, and the ratios are used to form a determination, the determination result remains the same whether the average or the sum of n times thereof is used, it is preferable to use the method of using the sum as this involves less computation.

Moreover, the frequency characteristics are provided by sin(πnf)/sin(πf), they are LPF characteristics wherein a notch exists in the ½n of the frequencies of the clock frequencies (the point where the output become zero). It is called a less than ½n of an outline clock LPF. In this embodiment, n=10 kHz/(2·150 Hz)≈33 is employed.

Now, in the event of deriving the sum of n sequential units, an n−1 adder may be used, but it may also be configured from one adder and one subtractor each. That method involves subtracting the oldest data from among the elements when the most recent sequential n units are summated, and the data may be added this time. If this kind of configuration is adopted, the amount of hardware can be miniaturised in the latest LSI processes or FPGA enabled using them.

Next, consider the sum of n signals passing through this LPF. They are hardly modified each time because the signals are sufficiently slow in respect of the clock, all of the n times have almost exactly the same value, such that the sum thereof is n times a single value. In other words, the bit length after computation is increased by log₂ n bits. In the case of this embodiment it is increased by approximately 5 bits (log₂33≈5).

On the other hand, the sum of the random noise is almost the square root of n times (√n times) because it is provided by the square root of the sum of the electrical power of the noise. In other words, the signal-to-noise ratio is improved to n/√n=√n times.

As this is the resolution of the ADC comprising the quantitisation noise or the effective bit number resulting from 1LSB, the quantitisation noise in respect of the signal is improved by √n times and, when converted to a number of bits, it is then increased by (log₂ n)/2 bits. In this embodiment, the resolution is improved by √33≈5.7 times, and in terms of number of bits, it is increased by approximately 2.5 bits and employs an equivalent value to the use of a 27.5-bit ADC (the effective bit number is 22.5 bits) employed. This is a greatly improved resolution effectiveness (5.7 times) which is much better than the resolution improvement effect (five times) resulting from the 5× amplifier INA of the prior art embodiment described in paragraph 0014, but this is derived enabling the digital filter effectiveness of FIG. 1 of this patent application. In other words, the 5× amplifier INA of FIG. 1 of this patent application is unnecessary.

Now, the commercially available ADC have been developed as products for every third bit, and as a two-bit performance in improvement means a one rank improvement of performance, if there is a two-bit or more improvement using the above described invention, it can be said to be a great improvement. The value of n in this case is 16 or more.

Now, if a 24-bit resolution ADC (the effective bit number is 20 bits) is employed with a commercial 4-megahertz clock, even when the 10 units of input are time shared because a clock frequency per channel of 400 kHz is enabled, a √40 times resolution improvement is enabled in the embodiment described above.

Moreover, if a 14-bit ADC (the effective bit number is 13 bits) is used with a commercial 50 MHz clock because a clock frequency can be set to 5 MHz per channel, even when the 10 units of input are time shared, a restriction of signal bandwidth to 150 Hz, n=1 MHz/(2·150 Hz)√1667, is possible. The number of resulting bits (log₂ 1667)/2≈7-bit of improvement is enabled, which is an equivalent value to an effective 21-bit ADC (the effective bit number is 20 bits), and even this yields satisfactory characteristics.

By means of the above, an explanation was provided for a device of the first embodiment of this patent application with higher resolution than the prior art circuits of FIGS. 2 and 3. As direct connection to the ADC is enabled without any analogue parts, it is evident that the analogue circuit alone can be miniaturised and reduced in cost and requires lower power consumption.

Moreover, the area taken up by digital circuits of adders and subtractors enabled by recent semiconductor processes is extremely small, and the power consumption is low. Further, this degree of computation may be performed by a CPU or a digital signal processor (DSP) which performs the overall processing, and in that case, there is no additional cost.

Now, when there is a lot of low-frequency noise, it goes without saying that in addition to the above, a simple digital high-pass filter may be provided in the digital filter of FIG. 1. By this means, for example, the noise from commercial power sources (the so-called hum) may be reduced, and 1/f noise may also be reduced.

Furthermore, the signal frequencies output from the above described sensor, the clock frequencies of the ADC or the number of bits, and the format of the digital filter and similar are but one embodiment and, as the above described effectiveness is enabled with any value, as long as it can be embodied, an optimal value may be selected to match the required characteristics.

### Embodiment 2

FIG. 4 is a representation of the second embodiment of this patent application, and connects a sensor outputting the capacitance variation represented in paragraph 0008 directly to an ADC.

For the method of extracting the capacitance variation, a method resembling the method disclosed in non-patent reference 1 of this patent application is used. The outline of this method is, firstly, that the capacitance of the sensor is charged with the basic voltage and the accumulated charge is connected to the already known input capacitance of the ADC and the electrical charge is redistributed and the sensor side capacitance is computed by analogue-to-digital conversion of that resulting voltage.

The circuit operations of FIG. 4a are firstly the closing of electronic switches S2 and S3 and the grounding thereof, the connection of S1 to the voltage source side (for example, Vr—2.5 V), and the charging of the capacitance sensor means. Next, the electronic switches S2 and S3 are opened, and S1 is connected to ground, the electrical charge accumulated in the capacitance sensor means is applied to the input means of the ADC, the electrical charge is redistributed with that input capacitance. In the event that the total input capacitance C_{ADC} including the floating capacitance of the ADC is discharged in the initial period, the voltage after charge redistribution becomes Vᵣ/(1+C_{ADC}/C_{S1}). The C_{S1} here is the sensor capacitance. In the event that C_{S1}<<C_{ADC}, it can be approximated to Vᵣ·C_{S1}/C_{ADC}. The same applies for C_{S2}. In order to simplify the following explanation, this approximation formula is used, but the computation without approximation is not being prevented. These differential voltages almost analogue-to-digitally convert Vᵣ·(C_{S1}−C_{S2})/C_{ADC}.

In this type of situation, there is no need to be particular about a successive comparison AD converter having a capacity provided by the geometric progression of ½ of a common ratio represented in non-patent reference 1. For example, as long as it is an ADC which enables fore knowledge of the input capacity including the floating capacity even if similar to that actually measured initially, the format does not matter. A normal ADC of a type wherein a known capacitance is additionally connected to the input may be used. In any event, the voltage differential after the above described charge redistribution can almost analogue-to-digitally convert Vᵣ·(C_{S1}−C_{S2})/C_{ADC}. If the variations in the capacitance are ΔC_{S1} and ΔC_{S2}, because it becomes ΔC_{S1}≈ΔC_{S2}, from the structure represented in FIGS. 4a and 4b, the differential voltage after charge redistribution of the variable part becomes almost 2·VᵣΔC_{S1}/C_{ADC}.

FIG. 4b shows a known input capacitance of the ADC. This is a modification of the second embodiment, a successive comparison type ADC which is initialised at a specific voltage (for example, half of the standard voltage V_{ref}). The capacitance of the sensor side must firstly have a second voltage charged thereto which is different from the specific voltage. If that were not the case, then the input capacitance of the ADC and the charge redistribution would not occur. FIG. 4b selects the second voltage as 0 V. In that situation, the input capacitance of the ADC is the charge which is charged thereto, and charge redistribution to the capacitance of the sensor which is being subject to measurement occurs, but the formula after charge redistribution may apply the items described in paragraphs 0025 to 0026.

Moreover, in the case of an ADC of a format as represented in non-patent reference 1, the measurement resolution of the capacitance is adversely limited by the limitations of the resolution of the switch capacitor means of the input means of the ADC, but the derivation of the required capacitance resolution is enabled by adapting to match the known methods elevating the resolution using the coupling capacitance C_{c} of FIG. 4b.

In FIG. 4b, the switch for use in input connection included in the successive comparison type ADC is used advantageously and the only new addition is the switch shorting the output of the capacitance sensor to 0 V. This switch could be configured by an NMOS transistor but is not limited thereto. Moreover, the timing of turning this switch on could, simply by selecting the half cycle of the inactive switch for input connection, be included in the earlier described successive comparison type ADC of the clocks provided in the ADC but it is not necessarily limited thereto. This, of course, presumes the development of a dedicated integrated circuit but may be easily enabled by merely adding an NMOS circuit to an existing ADC.

Now, there is no limitation to the manner of input of the switch in FIGS. 4a and 4b and configurations enabling other charge redistribution may also be employed.

By means of the above, it has been demonstrated that the sensor and ADC may be connected directly, without employing an oscillator or amplifier, a synchronous detection wave and a rectifier circuit as is conventionally the case, in order to extract the capacitance variation.

As there is no LPF included in the embodiment as in the conventional rectifier circuit as mentioned in paragraph 0008, there is no antialiasing filter effect.

However, in the case of an acceleration sensor, there is a limit to the physical speed of movement of the moving parts, for example, there is no response possible at 1 MHz. Therefore, the capacitance variation of an acceleration sensor is lower than 1 MHz. This also applies with respect to the noise vibration generated in these moving parts. In the embodiment described here, because there is no oscillator or amplifier, synchronous detection wave and a rectifier circuit between the sensor and the ADC, as was conventionally the case, there is no need to consider the high band noise generated thereby.

Therefore, if analogue-to-digital conversion is enabled at high sampling frequencies which are twice the maximum speed at which the moving parts can physically move (for example 10 MHz), there is no frequency aliasing of the noise from the sensor. In other words, there is no requirement for the provision of an antialiasing filter.

However, because there is no noise between the signal frequency upper limit (for example 100 Hz) and halfway to the clock frequency of the ADC, or a filter for the noise below the signal frequency lower limit (for example 50 Hz), these noises are analogue-to-digitally converted as they are and output.

The digital filter illustrated in FIGS. 4a and 4b is used to remove this. Firstly, a digital LPF for the signal frequency upper limit is used. The configuration method of the digital LPF may use known types of filters and similar, such as Chebyshev type FIR or biquad Infinite Impulse Response (IIR) filters, either would suffice. As a simple example of a digital LPF, the moving average filter of n units represented in embodiment 1 of this patent application may be used. Just as in embodiment 1 of this patent application, there may be selection of n≤clock frequency/(2·upper limit of the signal frequency).

When considering the sum of n units of signal passing through this LPF, as represented in embodiment 1 of this patent application, the signal-to-noise ratio is improved by √n times. As this is also established with respect to the resolution of the capacitance of the ADC, in other words, the quantitised noise with respect to the signal is improved by √n times and, when converted to number of bits, it is increased by (log₂ n)/2 bits.

At this point, when C_{S1}<<C_{ADC}, or when the capacity variance compared with C_{S1} is low, it may be that it becomes an extremely small voltage with respect to the full scale of the ADC. As one example when the sensor capacity C_{S1} and C_{S2} are 1 pF, and when the amount of variation thereof ΔC_{S1}, ΔC_{S2} is 0.1 pF, and the C_{ADC} (including floating capacitance) is 10 pF, because the amount of variance is C_{S1}/C_{S2}=0.1 pF/10 pF=0.01, when a 24-bit ADC is used, it effectively corresponds to a 14-bit ADC.

When the method described in embodiment 1 is employed in that situation, the clock frequency of the ADC is elevated sufficiently so as not to have aliasing noise (for example, making it 10 MHz), then the resolution may be effectively increased using a digital filter.

On the other hand, the filter scale of a normal ADC in most cases may be selected from between 1 V to several volts, and there are many situations where it cannot be used effectively from one extreme to the other as in embodiments 1 to 2 of this patent application. In that case, for example, if the input voltage range of the ADC is set to less than one quarter, the voltage of the above described charge redistribution can be covered. By enabling this, as a 1 LSB voltage becomes less than ¼, the resolution can be further elevated to greater than two-bit.

By combining these, it is apparent that the output of the capacitance sensor can be digitised by any ADC at the desired resolution.

### Embodiment 3

FIG. 6 represents the third embodiment of this patent application and connects the sensors of FIGS. 6a and 6c which output a minute current as represented in paragraphs 0009 and 0010 directly to the ADC. FIG. 6b is connected to the ADC via the current/voltage conversion device.

In FIG. 6a, the minute current Iₛ output by the sensor flows into the resistor R_{L}, generating a voltage of Iₛ×R_{L} according to Ohm's law and this is directly analogue-to-digitally converted and the noise thereof is reduced by the band limitations of a digital filter to elevate the resolution.

For example, when Iₛ=1 nA, on selecting R_{L}=10 MΩ, a 10 mV potential is derived. When analogue-to digitally converting this, for example, just as in embodiment 1, a commercially available 2.5 V full scale 24-bit 100 kHz clock ADC may be employed (effective bit number is 20 bits). As 1 LSB=2.5 V/2²⁴=0.15 μmol, because a 10 mV signal is equivalent to approximately 67,000 LSB, an approximately 16-bit resolution is derived. The effective bit number becomes 12 bits.

What must be kept in mind here is the floating capacitance of the sensor itself, the floating capacitance of the wiring, the floating capacitance of the resistor R_{L}, and the total sum Cᵢ of the input capacitance of the ADC.

This and the resistor R_{L} configure the primary LPF and the cutoff frequency f_{c} thereof is provided by 1/(2πCᵢR_{L}). For example, if Cᵢ=5 pF, f_{c}≈3 kHz.

According to FIG. 18 of non-patent reference 3, because the time width of the signal is of the order of 2 μs, this corresponds to approximately 0.5 kHz, and if it is f_{c}≈3 kHz, then it is sufficiently within the band and the signal will be reduced. In other words, it is eminently usable.

Now, the floating capacitance of the sensor itself and the wiring capacitance form a well-known driven shield and, as it is a configuration which can be almost ignored, if this is used the Cᵢ may be used in reduction as required.

FIG. 6b represents the case where the well-known current voltage (IV) conversion circuit is used instead of the resistance of FIG. 6a and is also used even in non-patent reference 4 represented in FIG. 8. When enabled in this manner, it is easy to think at a glance that the signal is amplified, but the minute current I_{S} which the sensor output delivers to the resistance R_{L} and simply generates a potential of I_{S}×R_{L} according to Ohm's law and the size of that potential, other than encoding, is the same as 6a.

However, because the frequency characteristics are determined by the resistance R_{L} and the floating capacitance that the resistance R_{L} has, the sum of the above described floating capacitance Cᵢ has the advantage that it can be made to work explicitly on the frequency characteristics. However, the input conversion noise of the op amp used in the IV converter has the associated disadvantage of being Cᵢ/C_{L} times in the high band.

Nevertheless, in the embodiment of this patent application, the circuit of FIG. 6b is not particularly removed.

In FIG. 6c, a switched capacitor circuit is used instead of the resistance in FIG. 6a. When the electronic switch S₁ is closed, the floating capacitance of the above described sensor itself, the floating capacitance of the wiring and the floating capacitance of the resistor R_{L} discharge the sum total Cᵢ of the input capacitance of the ADC. Next, when the electronic switch S₁ is opened for only a specific period τ, the Cᵢ is charged up to potential Is·τ/Cᵢ. This potential is analogue-to-digitally converted at the ADC.

When the ADC, for example, is the capacitance input type represented in FIG. 4b, and when the input signal is of a type charged into that capacitance, the combined charging to the above described Ci has good affinity. However, it is not limited to that. Furthermore, the configuration of the electronic switch is not limited to that of FIG. 4b and, as long as it is a circuit which charges or discharges for a specific time period τ, any one such type could also be used. As one example, when the sensor output is 1 nA, and the input capacitance is 10 pF and when the charging duration τ is 1 ms, it becomes 1 nA·10 μs/10 pF=1 mV and when a 2.5 V full scale 24-bit ADC is used for analogue-to-digital conversion, the analogue-to-digital conversion is enabled at a resolution of effectively 12 bits.

In the case of FIGS. 6a to 6c, while an LPF is provided as a circuit, as it is not one which matches the upper limit of the signal band, an LPF is required to narrow down to the desired signal band. However, in the third embodiment of this patent application, there is no analogue LPF which the conventional embodiments of FIGS. 7 and 8 of this patent application had. In that respect, a digital filter is incorporated in the circuits of FIGS. 6a to 6c and processes are performed which only pass through the desired signal band. As the details thereof are the same as in the first and second embodiment of this patent application, further details thereof are dispensed with here.

In addition, by means of analogue-to-digital conversion with a sufficiently higher clock than the signal band and by narrowing the band using a digital filter, just as in the first and second embodiment of this patent application, the resolution is, of course, improved.

By this means, this invention may be adapted to sensors with a minute current output, with the benefit that analogue parts are almost unnecessary.

### Embodiment 4

In embodiments 1 to 3 of this patent application described above, it is essential to have a digital filter. For that reason, the following is a proposal of a method to further use that digital filter advantageously. The characteristics of the digital filter are such that a variety of frequency characteristics are enabled easily by changing the coefficient.

In embodiments 1 to 3, it is natural that the bands of the digital filter are preset to the maximum range of the frequencies which are thought to exist in the signal from the sensor. In embodiment 4, this is optimally controlled by matching to the actual sensor output, in what is called an adaptable filter.

For example, a digital filter block (not illustrated in the figures) is created by arraying multiple digital filter units in parallel which have different cut-off frequencies. By selecting the least signal attenuation and the greatest noise reduction from among these digital filter unit outputs, as the signal band may be narrowed to the utmost compared to predetermined bands, a reduction in noise is enabled.

As an example of a single digital filter, considering a moving averages type, one which varies the average taken of n units of sequential data is prepared. In that situation, if the clock of the ADC is high, because the value of n is higher, the resolution can be defined which is an advantage. For example, compared with those in which n=4 and n=5 with a resolution of ¼ to ⅕, the resolution when n=40 and n=41 is 10 times finer when the resolution is 1/40˜ 1/41.

Now, if the sensor output is accumulated in a sequential memory (not illustrated in the figures), by varying the coefficient multiple times, sequential processing of the data in the memory is enabled with just one digital filter, enabling the derivation of effectiveness similar to that of previous paragraphs.

In that event, it is obvious that the frequency characteristics of the digital filter can be varied gradually but by employing the bisection method or the Newtonian method, convergence on the frequency characteristics is enabled.

There is a raw data graph in FIG. 26 of non-patent reference 3 representing the passing of sensor output through a fixed analogue LPF followed by analogue-to-digital conversion.

While there is the difference between non-patent reference 3 and this patent application of the filter being analogue or digital, theoretically, no matter which one is employed, the frequency characteristics can be set to be equivalent.

In that respect, in order to represent a comparison of the effectiveness of digital filtering using the conventional fixed analogue LPF and the digital adaptive filter of embodiment 4 of this patent application, the inventors read off each point of that waveform graph and used them when digitised. The result of that is represented in FIG. 9a, the right-hand side is a re-graphing of the waveform of the digitised values of FIG. 26 of non-patent reference 3 and the waveform is almost the same as the conventional embodiment of FIG. 26 of non-patent reference 3. The left-hand side represents the digital values after digitisation thereof presented as a histogram. While the individual values of this histogram are different, of the approximately normal distribution curves represented by the four broken lines, the state of the intersection of the edges of three of them are the same as the tendency of the histogram of FIG. 26 of the original non-patent reference 3. In addition to the intersection of the edges of the approximately normal distribution curves, it is clear that they cannot be separated by merely comparing the levels of the waveforms. Conventionally, that further processing was needed in order to distinguish them is cited in non-patent reference 3.

FIG. b represents digital filter processing by the inventors of this patent application of the digitised values, presented as a graph. Specifically, in this example, a moving average type digital filter was applied, several [values of] n were tried and it was determined as 4 by the procedure described in paragraph 0048. As the results thereof show, it can be appreciated, at a glance, that the signal was not diminished much, and there is a clear reduction in noise.

As a side effect in FIG. 9b, because the band was narrowed by slightly less than a ¼, it can be appreciated that the upswing and downswing slope characteristics have been smoothed. Here, the almost flat parts and the peak parts of the graph in that diagram are desirable as an effective signal. On the other hand, the slopes or the intermediate points of the upswing and the downswing were generated by filter processing, and it is important to note that they are not useful signals. Therefore, there should be processing to remove the sloping parts of the upswings and the downswings.

As a specific example of that, in the graph of that same diagram, there is the output of positive and negative values of peaks or flat parts (in other words, values which are the same as the previous ones), wherein there is computational processing to sustain the immediately prior value. When this is graphed and represented as a histogram, it appears as in FIG. 9c.

In the histogram of FIG. 9c, at the edges of the approximately normal distribution curves represented by the four broken lines, there is no intersection of the ±3σ order. Expressed in another way, these can easily be distinguished by a simple level comparator apparatus. Now, the threshold values of the comparator apparatus, for example, if there is computation of ±3σ values in respect of each level, then the intermediate point may be employed as the threshold. Looked at from the opposite perspective, this means that, mostly, each normal distribution of FIG. 9a is actually not signal components but noise components that form a normal distribution, and that the distribution can be narrowed by reducing the noise to make the bands narrower.

### Embodiment 5

In embodiment 5, in order to further narrow the noise bands, there is a proposal to narrow down the pass-through bands of the filter to be narrower than the effective signal. By means of this, the normal signal status soon disappears, and it turns into a partial response status.

Employing a digital filtering method, on computing with the signal and a specific proportion of the delayed signal, these are overlaid, but a manner of reducing the overall band was employed. In general, a partial response status means the use of a filter so as to have frequency characteristics which are equivalent to the digital filter bands, and even if they are overlaid signals, has the advantage that, if the initial values can be understood, sequential deciphering based on that is enabled.

As simple examples, there are the so-called PR1, or the duo-binary. For example, consider a digital pulse stream comprised of inputs which are 0 or is, and the sum of that with a signal delayed by one signal interval. For example, if the input is a signal converted to 0, 1, 1, 0, 1, 0, 0 . . . , then the sum of with the signal delayed by one signal interval i.e. 0, 0, 1, 1, 0, 1, 0 . . . is simply 0, 1, 2, 1, 1, 1, 0 . . . . In other words, it becomes three values. And even with the input of multiple values, the computation is similar. The characteristics thereof in a z function are annotated as 1+z⁻¹, and it is known that the frequency band thereof becomes sin(2πfτ)/sin(πfτ)=2 cos(πfτ). The τ here is the duration of a one signal interval. Here, when f=½τ, the transfer function becomes zero, and this is a frequency characteristic, wherein the basic wave components of the signal do not pass through. Because this is a band characteristic in which only one part of the frequency of the signal reacts, this is prior art technology called partial response. Because this also results in the removal of noise in the vicinity of the basic signal frequency, just as with the signal, further noise removal is possible.

Since the result of applying this filter based on the definition described above is the total of the value of the present input signal and the value of the immediately prior input signal, the value of the present input can be decoded by deducting the immediately prior decoded value from the filter output. However, there is only a need to input the initial value (normally a 0).

Moreover, in the situation where, for example, the band is limited by the floating capacitance represented by the broken line of FIG. 6a, it becomes equivalent if a digital filter is prepared such that the frequency characteristics match those of the band described above. Expressed in another manner, even when the Cᵢ of that same figure is great, and when so narrow as to not pass the entire signal band, the signal can be encoded if a digital filter is employed to match the above equation.

A definition of the partial response z function is enabled, and, other than the above described 1+z⁻¹, various creations are possible, such as 1+z⁻², or 1+z⁻¹−z⁻²−z⁻³ etc. There is a variety of known methods of grossly simplifying the decoding of the filtering result, and there is no limitation to the embodiment represented in paragraphs 0055 to 0056. While a different decoding method from that by the z function is possible, it can also be simply decoded using the decoded values of immediately prior multiple decoded values. Moreover, it is known that the effects of noise may be further reduced by combining with one type of error correction methods called maximum likelihood decoding.

FIG. 11 depicts the addition of a signal delayed by 6 clocks worth of ADC, corresponding to one signal equivalent to the signal of FIG. 10b, and represents the partial response status of a narrowed band as a waveform graph. In order to narrow the band, the narrow hills and troughs are caused to disappear. The noise of the adjacent frequencies also disappears at the same time. As already described, the initial value is set as 0, and firstly the initial value of the partial response status is output as the initial decoded value, and the next decoded value is output by subtracting the output of the immediately preceded decoded value from the next value of the partial response status, . . . such that the replay of a sequentially decoded output is enabled.

To summarise, further noise removal is enabled by applying a digital filter with so narrow a band as to only pass part of the band of the frequency band signal. While that output is a multi-value status that overlaps signals in that output, the demodulation method is already known, and because the communication and hard disks have already been developed, this can be reused.

### INDUSTRIAL APPLICABILITY

In each of the embodiments of this patent application, firstly, the sensor output is digitally converted either immediately or with the use of a minimal amount of analogue circuitry. The noise generated by large analogue circuitry, as in the prior art, is avoided, making miniaturisation and low power consumption possible and enabled at reduced cost. Secondly, the inadequate resolution and frequency in aliasing noise which could conceivably occur for the lack of the conventional amplifier and antialiasing filter are addressed by the use of a conversion clock of the ADC in this invention being set sufficiently high so as not to be able to respond to the sensor, and a digital filter is employed, such that the signal is barely passed, or passes the frequency band in a partial response mode, to resolve those issues. The ADC for this purpose is feasible and commercially available products can be used.

The present invention may be adapted to a wide variety of sensors, and broadly enables noise reduction, miniaturisation, low power consumption, and cost reduction, such that the industrial effects are extremely great.

Now, there is no limitation to the embodiments exemplified of the present invention, and parts may be cut out and implemented, and may be enabled in any combination.

### BRIEF DESCRIPTION OF THE DRAWINGS

FIG. 1: A minute current output type sensor signal detection device of the first embodiment.

FIG. 2: An example of the conventional minute current output type sensor signal detection device.

FIG. 3: An example of the conventional minute current output type sensor signal detection device.

FIG. 4: A minute current output sensor signal detection device of the second embodiment.

FIG. 5: An example of the conventional capacitance output type sensor signal detection device.

FIG. 6: A minute current output sensor signal detection device of the third embodiment.

FIG. 7: A conventional minute current output type sensor signal detection device in the first embodiment.

FIG. 8: A conventional minute current output type sensor signal detection device in the first embodiment.

FIG. 9: The output waveform of the sensor signal detection device of the fourth embodiment.

FIG. 10: The output waveform of the sensor signal detection device of the fifth embodiment.

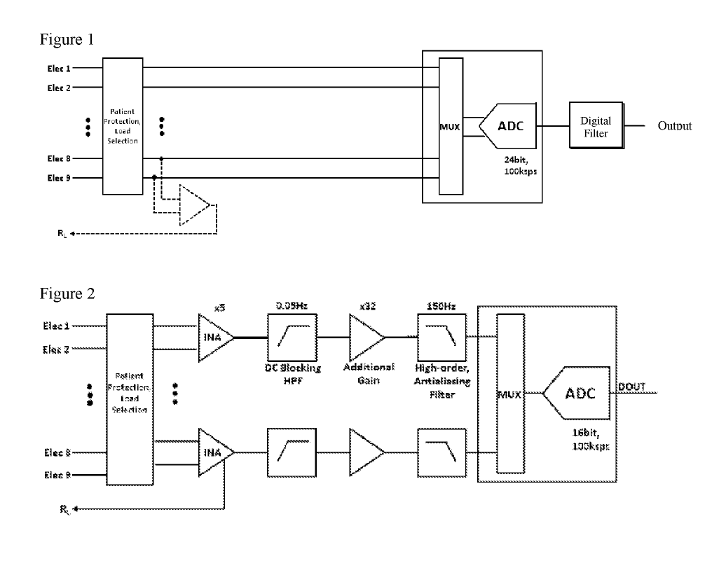

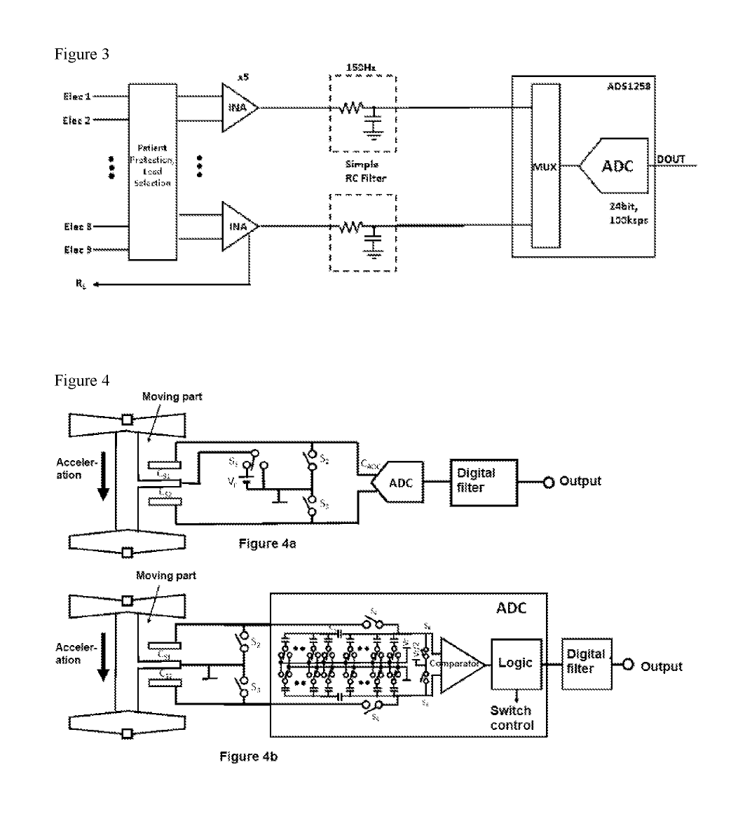

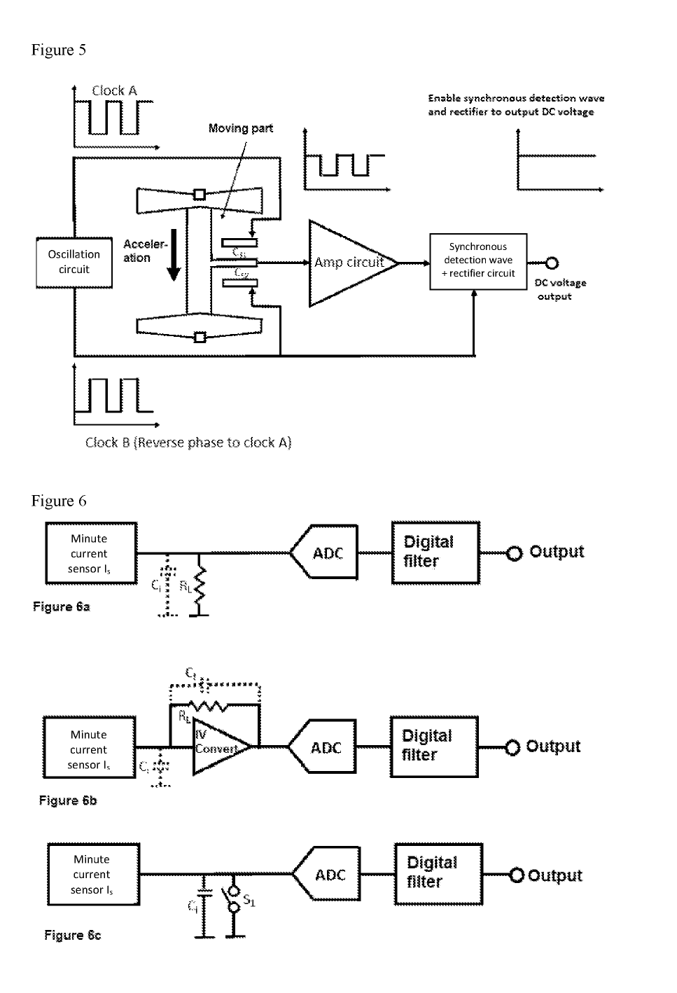

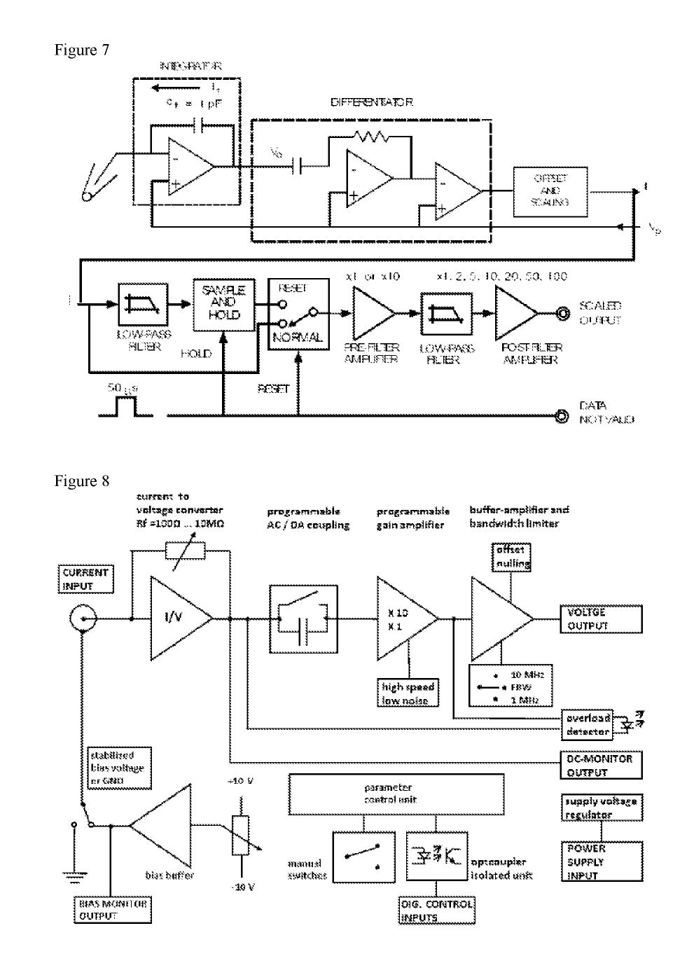

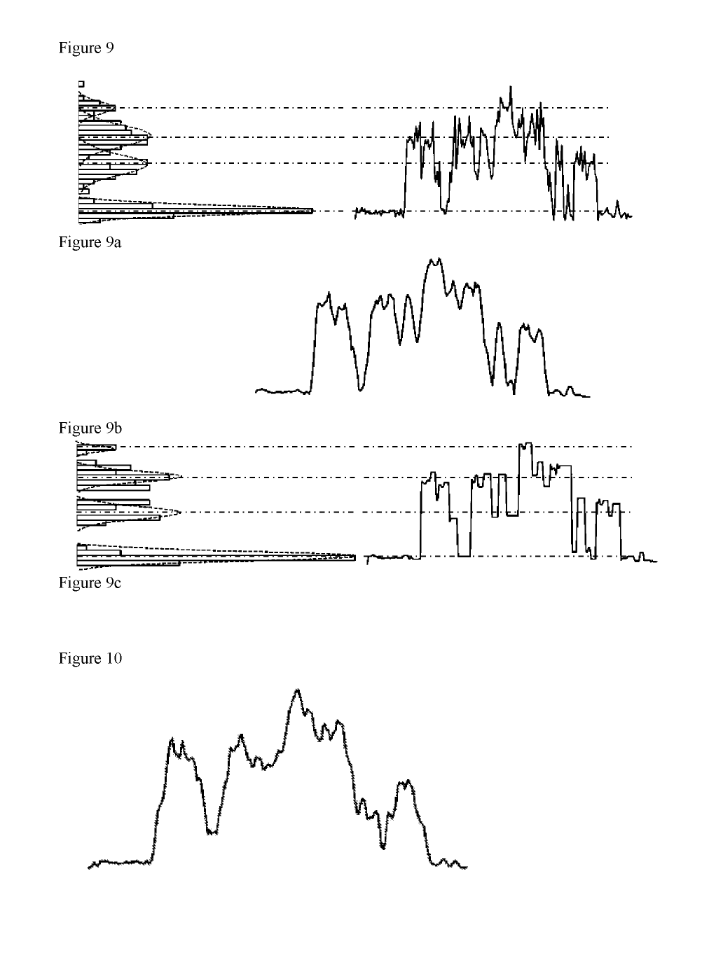

### EXPLANATION OF THE REFERENCE NUMERALS

S₁ to S₆ switching circuits
C_{S1} to C_{S2} sensor capacitance
Cᵢ, C_{f} capacitance
   R_{L} resistors

1. A sensor signal detection device comprised of an A/D converter either directly inputting the electrical signal output of the sensor or inputting via a means which converts to a voltage, and a programmable digital filter receiving said A/D converter output, and reception part of said filter output,
characterised by setting the conversion clock frequency of said ADC to at least twice the physical maximum output frequency of the noise which may be included in the sensor output, and setting the pass-through upper limit frequencies of said programmable digital filter such that at least part of the electrical signals of said sensor are frequencies which are passed through, setting the band so as to reduce the strength of the noise included in the electrical signals of the sensor, as well as reducing the effective resolution of said A/D convertor to at least the square root of said pass-through upper limit frequency/said clock frequency.

2. A sensor signal detection device, characterised by adding a control means to the sensor signal detection device claimed in claim 1 in order to optimally control the pass-through upper limit frequencies of said programmable digital filter, based on a signal related to the output signal of said programmable digital filter itself.

3. A sensor signal detection device, characterised by the sensor signal detection device claimed in claim 1 comprising a means for computing the additive values of multiple input values which are equally spaced with respect to time, as said programmable digital filter.

4. A sensor signal detection device, characterised by the sensor signal detection device claimed in claim 1 setting the pass-through lower limit frequency band of said programmable digital filter to pass through the expected minimum frequencies of the electrical signals of said sensor, in addition to setting the band to reduce the strength of the low band noise included in the electrical signals of the sensor.

5. A sensor signal detection device, characterised by the sensor signal detection device claimed in claim 1 setting the conversion clock frequencies of said A/D converter to at least several times the expected frequency of the electrical signals of the sensor,
and reducing the strength of the noise included in the electrical signals of the sensor, by means of setting a partial response status to less than the expected frequency band of the electrical signals of said sensor,
as well as adding a control means controlling the bands of said programmable digital filter bands to the bands of the desired partial response status and decoding the partial response status signals.

6. A sensor signal detection device, wherein the sensor signal detection device claimed in claim 1 is characterised by the resolution being increased by two or more bits, by means of normally setting the reference voltage of said A/D converter to less than ¼.

7. A sensor signal detection device, wherein the sensor signal detection device claimed in claim 1 is characterised by comprising a sensor outputting a minute voltage.

8. A sensor signal detection device, wherein the sensor signal detection device claimed in claim 1 is characterised by comprising a sensor outputting a capacitance value or a varied capacitance value,
and setting a switching means redistributing the charge accumulated, including the capacitance of said sensor and the input capacitance of said A/D converter including zero,
and A/D converting the potential generated by the input capacitance of said A/D converter by means of said redistribution.

9. A sensor signal detection device, wherein the sensor signal detection device claimed in claim 1 is characterised by comprising a sensor outputting a minute current, and A/D converting a voltage related to the voltage drop when said minute current is passed through a resistor.

10. A sensor signal detection device, wherein the sensor signal detection device claimed in claim 1 is characterised by comprising a sensor outputting a minute current,
and A/D converting the specific duration of said minute current, the charging voltage after charging the input capacity of said A/D converter, or the discharge voltage.
